(19) United States
(12) Patent Application Publication
(10) Pub. No.: US 2012/0294586 A1
(43) Pub. Date: Nov. 22, 2012

(54) CONTROLLING TIME-SENSITIVE CONTENT IN A TIME-SHIFTED ENVIRONMENT

(76) Inventors: David John Weaver, Fishers, IN (US); Martin Vincent Davey, Indianapolis, IN (US); Chaminda Jayamanne, Fisher, IN (US)

(21) Appl. No.: 13/294,211

(22) Filed: Nov. 11, 2011

Related U.S. Application Data
(60) Provisional application No. 61/458,165, filed on Nov. 18, 2010.

(51) Int. Cl. H04N 9/80

(52) U.S. Cl. 386/248; 386/E09.011

(57) ABSTRACT

A device for recording a scheduled program comprises a means adapted for receiving data from a multi-program transport stream system that is configured to transmit multiple audio or video programs over a channel in multiple streams, the multi-program transport stream system further providing program identifiers to the streams in the channel that identifies a first program identifier with a first stream having at least a portion of a scheduled program and indentifies a second program identifier with a second stream having the scheduled program in its entirety; and a storage means adapted for identifying the scheduled program by the second program identifier and recording the scheduled program in its entirety while the unscheduled interrupting program is provided in real time.

### CROSS-REFERENCE TO RELATED APPLICATION

This application claims priority from U.S. Provisional Application 61/458,165 filed Nov. 18, 2010 which is incorporated by reference herein in its entirety.

### FIELD OF THE INVENTION

The invention is related to video recorder devices and methods of recording video data therein.

### BACKGROUND OF THE INVENTION

Users of conventional personal video recording devices such as digital video recorders normally expect to see programming that they scheduled in the time slot that the users either automatically or manually programmed.

Occasionally, however, the network carrying a scheduled program may interrupt the program with some unscheduled content. For instance, in the case of local breaking news or severe weather, some networks preempt shows in order to broadcast their breaking news or provide information on severe weather. These preemptions unfortunately cause the viewer to lose some portion of their scheduled program both in the live broadcast and in the system storage of the video recorder.

To ensure that a complete program is aired, some broadcasters will and have extended the programming time of the scheduled program when there has been some interruption. This, however, causes at least two problems: a first problem is that the extended broadcast interferes with program times of the following scheduled programs and a second is that the viewer will either miss a portion of intended scheduled program if the recording time is not scheduled to go beyond the intended scheduled program end time. On the other hand, if the viewer or the viewer's recorder extends the recording times to times beyond the intended scheduled program end time to insure a complete recording of the intended program, the viewer's video recorder will have used additional storage space and this will cause the recorder to more rapidly reach its storage limit.

FIGS. 1 and 2 show the present and restrictive way of handling a network interruption. FIG. 1 shows a time line 101 for a scheduled program 107 to be broadcast in real time by a network having a program start time 102 and a program end time 103. FIG. 1 further shows a special report 104 having a start time 105 and an end time 106 which are both within the scheduled program start time 102 and the program end time 103, and thus, the special report 104 interrupts the scheduled program 107. After the special report 104 ends, the network returns to the scheduled program 107. Essentially, as shown in FIG. 1, the user misses part of the scheduled program in real-time if the network returns to the scheduled program at a point in time of the scheduled program 107 where the schedule program would have advanced to if scheduled program had been running during the special report 104.

FIG. 2 shows how the broadcast of the network is recorded by a personal video recording device 210 according to a known methodology. As in FIG. 1, here in FIG. 2, the network presentation is shown in real time in time line 101. The recorded time line 201 records in real time the broadcast of the network, wherein the program start time 102 for a scheduled program 107 and the program end time 103 are captured by the recording device 210 as recorded program start time 202 and recorded program end time 203, respectively. Further, the special report 104 is represented as recorded special report 204 in which the start time 105 and an end time 106 of the special report are captured as the special report recorded start time 205 and the special report recorded end time 206. After the special report 104 ends, the network returns to the scheduled program 107. What is observed here is that the recording device 210 recorded only part of the scheduled program and recorded the special report 204, thereby causing the viewer to miss part of the scheduled program in storage.

As such, a need exists for a video broadcast recorder system and methodology that is adapted to permit complete recording of intended scheduled programming in the intended scheduled programming timeframe when there is some preemption of the intended scheduled programming.

### SUMMARY OF THE INVENTION

A system is provided for recording a scheduled program on a channel having a scheduled time duration when an unscheduled interrupting program is broadcasted on the channel during the scheduled time duration of the scheduled program. The system can comprise a multi-program transport stream means that is capable of transmitting multiple audio or video programs over the channel; a means of providing program identifiers to programs that identifies the scheduled program by one program identifier and indentifies the unscheduled interrupting program by a different and unique program identifier; and a built-in storage means that identifies the scheduled program by the one program identifier and records the scheduled program in its entirety even when the unscheduled interrupting program is provided in real time.

A method is also provided that comprises the steps of: receiving a multi-program transport stream for a scheduled program, wherein the multi-program transport stream has at least a first stream having a first program identifier intended to broadcast the scheduled program and any potential preemptive material and a second stream having a second program identifier intended to broadcast only the scheduled program; scheduling to record the scheduled program by selecting the first or second program identifier; and recording the scheduled program selected in the scheduling step, wherein the multi-program transport stream can be a single channel or a single frequency and the first and second streams can be subchannels on a channel.

A device is also provided for recording a scheduled program that comprises a means adapted for receiving data from a multi-program transport stream system that is configured to transmit multiple audio and/or video programs over a channel in multiple streams, wherein the multi-program transport stream system further provides program identifiers to the streams in the channel that identifies a first program identifier with a first stream having at least a portion of a scheduled program and indentifies a second program identifier with a second stream having the scheduled program in its entirety. The device further can comprise a storage means adapted for identifying the scheduled program by the second program identifier and recording the scheduled program in its entirety while the unscheduled interrupting program is provided in real time. The storage means is adapted to record and store a recording in which the recording has a recorded program start time and a recorded program end time corresponding a scheduled program start time and the scheduled program end time.

Also provided is system for managing scheduled and non-scheduled programs. The system can comprise an encoder for creating a multi-program transport stream from at least a portion of a scheduled program and at least a portion of a unscheduled program, wherein one of the program transport streams includes only scheduled program content and another of the program transport streams includes both scheduled program content and unscheduled program content and the encoder assigns respective program identifiers (PIDs) to the program transport streams indicative of the scheduled and non-schedule content. Further provided are a transmitter for the program transport streams; a decoder for the program transport streams in which the decoder provides the scheduled program as a first output and has at least a first PID and the scheduled and non-scheduled program as a second output has at least a second PID; and a recorder that is adapted to automatically recognize the first PID and record the first output.

### BRIEF DESCRIPTION OF THE DRAWINGS

The invention will now be described by way of example with reference to the accompanying figures which are as follows:

FIG. 1 shows how a user can have their program interrupted in real-time by a network's special report according known systems;

FIG. 2 shows how a special report interferes with the recording a scheduled program according to known systems;

FIG. 3 shows how the system according to the invention records the complete scheduled program in the scheduled program timeframe when scheduled program is interrupted by a special report; and

FIG. 4 shows a block diagram view of an embodiment of the invention.

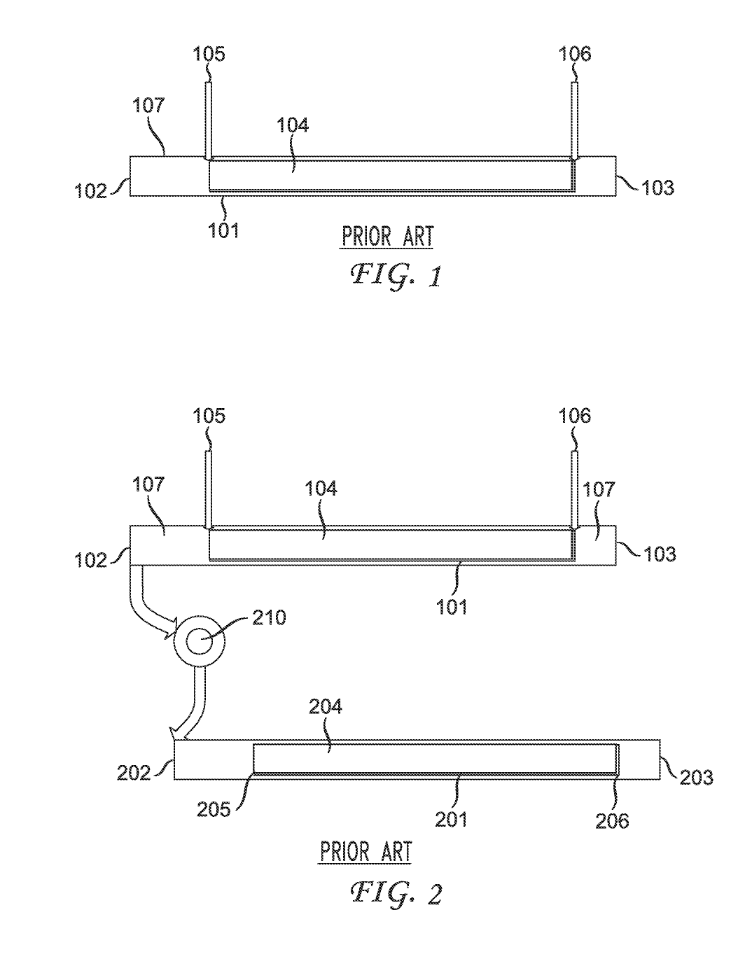

### DETAILED DESCRIPTION OF THE EMBODIMENTS

A process and system is presented to allow a user to record proper and expected program content regardless of network pre-emption to broadcast breaking news, severe weather alerts, time-sensitive material, or the like. The disclosed process and system provide a “best of both worlds” scenario with minimal impact on providers who can preempt scheduled programming with such special reports. The process and system can incorporate the existing and proven MPEG2's multi-program transport streams provided in digital transmissions, wherein a program can be recorded to the systems built-in storage while the alternate program can be displayed for the viewer in real time. The network can have their important messages shown at their time of relevance; however, when the user goes to watch the program they wanted to record at a later time, the user will not have to watch or fast forward through the special reports.

The system can require the broadcaster to have and provide secondary transport content at the time the network desires to show it. The new data which can be the special report can share the bandwidth of the existing channel, as required by the service provider. The ability to “share” a single digital channel is accomplished through multi-program transport streams (MPTS). The MPTS provides the means to transmit multiple audio and video data over the same channel, or frequency. The streams are differentiated by data PIDs, (program IDentifiers). Therefore, the main program, identified by its own unique set of PIDs, can be recorded uninterrupted on the personnel video recorder, while the secondary content which is identified by another set of unique PIDs can be decoded and output to the viewing devices.

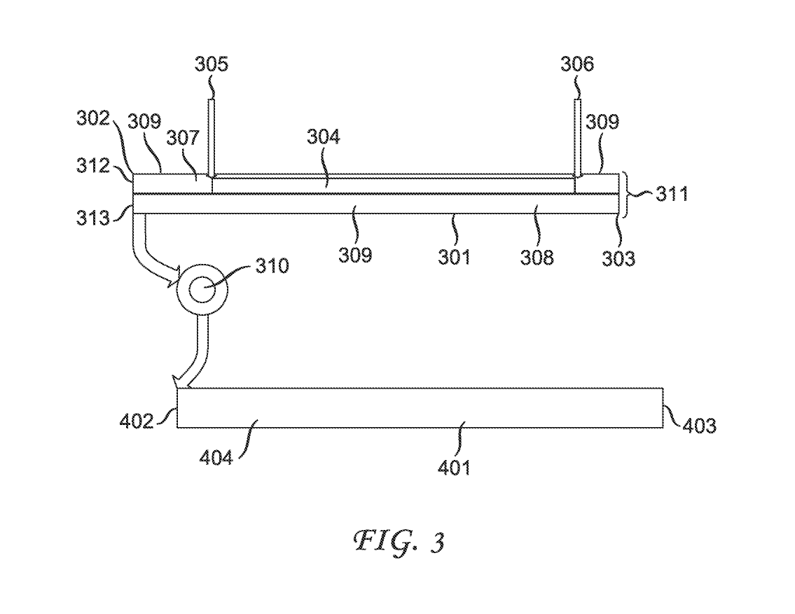

FIG. 3 shows an embodiment according to the invention in which a digital video recorder (DVR) 310 records the complete scheduled program in the scheduled program time when the scheduled program is interrupted by a special report. Here, a multi-program transport stream system 311 is shown and provided in which different PIDs are assigned for the different streams. The use of different PID values for the different content permits the users to record and save a scheduled program while the special report is still available during the real time viewing of the channel.

FIG. 3 shows a time line 301 having the program start time 302 and the program end time 303 for a scheduled program 309 in real time as broadcast by a network. FIG. 3 further shows a special report 304 having a start time 305 and an end time 306 in which both are between the program start time 302 for a scheduled program 309 and the program end time 303 in this example, and thus, the special report 304 interrupts the current program. After the special report 304 ends, the network returns to the scheduled program. Here, however, there are two streams of broadcast data each with a unique data PID, (program IDentifier). A first data PID 307 for a first stream 312 for a network broadcast is shown running simultaneously with a second data PID 308 in a second stream 313, wherein both are running in real time. The first data PID 307 includes the broadcast of the special report 304 and the scheduled program 309 and the second PID 308 runs the broadcast of the scheduled program without the special report.

FIG. 3 shows how the broadcast of the network is recorded by a personal video recording device 310 according to the invention, wherein the recording device 310 is programmed, configured or adapted to record from the second stream 313 by selecting the second PID 308. The network presentation is shown in real time in time line 301. The recorded time line 401 records in real time the broadcast of the network associated with the second PID 308 wherein the program start time 302 for a scheduled program 309 and the program end time 303 are captured by the recording device 310 as recorded program start time 402 and recorded the program end time 403, respectively, whereby a recorded program 404 is captured and stored and ready to be viewed at the convenience of the viewer. In other words, the complete scheduled program 309 is recorded as recorded program by the recording device 310, wherein viewers watching television in real time can see the special report 304 and viewers watching the broadcast captured on the recording device 310 can see the scheduled program.

An important feature of the invention is that the recording device is adapted to work in concert with the above-mentioned broadcast system that provides secondary transport content at the time the network desires to broadcast such content such that the recording device captures the scheduled program without the special report.

Other functionalities of the recording device can include the feature of the viewer being able to program the recorder to automatically record from both streams if there are special reports or interruptions such that the viewer can also see the special reports at a later time also if the viewer so desires.

Another feature of the invention can include the recording device 310 having the functionality to automatically prompt the user to go back to the scheduled program time at the time of the interruption (i.e., time 305) and play from the recorded device the scheduled program at the time of the interruption, if the viewer is watching the special report.

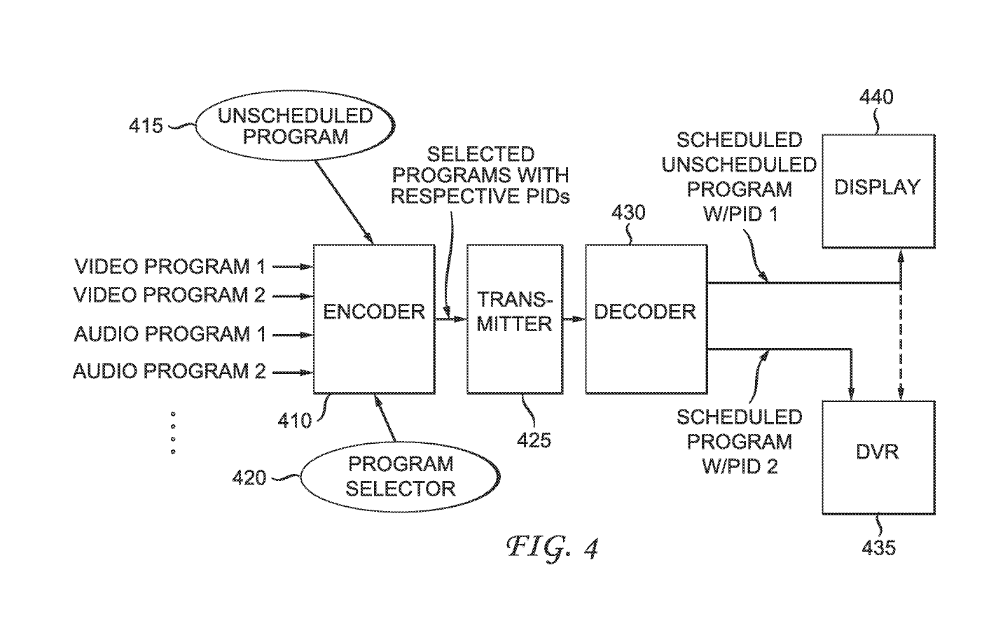

FIG. 4 is a block diagram view of an embodiment of the invention which is intended to provide structural features and a means of using the system described in FIG. 3. The system shown in FIG. 4 involves having video and audio data sent to an encoder 410, which can be an encoder of a provider. Here, video program 1 and audio program 1 can correspond to a scheduled program 1 that a provider can send to an encoder 410 and video program 2 and audio program 2 can correspond to a scheduled program 2 that the provider can send to an encoder 410. Further, the system can have some program selector feature 420 indicating what video and audio data to encode and some source 415 of providing unscheduled programming for the encoder 410 to encode with the selected scheduled program. The encoder 410 or the program selector feature 420 can provide PIDs for the scheduled programs and unscheduled programs. The system can further include a transmitter 425 which can receive the scheduled and unscheduled programs with their respective PIDs and transmit the scheduled and unscheduled programs, wherein the transmitter is adapted to transmit a multi-program transport stream of multiple audio or video programs 304, 309 over a channel in multiple streams 312, 313 to a decoder 430. Either the encoder or transmitter can make the multi-program transport stream. In the system, a DVR 435 can receive the decoded scheduled programming and decoded unscheduled programming that can be provided a multi-program transport stream. As shown in the figure, the DVR 435 can receive the first data PID 307 (PID 1) associated with a first stream 312 and a second data PID 308 (PID 2) associated with a second stream 313, wherein both are running in real time. The DVR 435 is adapted to automatically recognize the second data PID and record the output of the stream associated with the second data PID. The system can further include a display 440 which can receive and display in real time unscheduled programs that may preempt a scheduled program of the first data PID 307. In one example, the video/audio program 1 can be transmitted in two subchannels, wherein one subchannel can be used to show an unscheduled program. In other words, one subchannel can be one stream of only video/audio program 1 and the other subchannel will include video/audio program 1 and any unscheduled programming.

Further, embodiments of the invention include the situation in which the preemption goes over more than one program. In such a situation, if the user intends to record two or more adjacent programs and a preemption runs into both, the recording device can include the functionality to record both or all of the complete scheduled programs 309.

The foregoing illustrates only some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents

What is claimed is:

1. A system for recording a scheduled program comprising:
a multi-program transport stream means that is adapted to transmit multiple audio or video programs over a channel in multiple streams;
a means of providing program identifiers to the streams in the channel that identifies a first program identifier with a first stream having at least a portion of a scheduled program and indentifies a second program identifier with a second stream having the scheduled program in its entirety; and
a storage means that identifies the scheduled program by the second program identifier and records the scheduled program in its entirety while the unscheduled interrupting program is provided in real time.

2. The system of claim 1, wherein:
the scheduled program has a program start time and a program end time; and
the storage means records and stores a recording in which the recording has a recorded program start time and a recorded program end time corresponding the program start time and the program end time.

3. The system of claim 2, wherein the recorded program end time does not extend beyond the program end time.

4. A method comprising the steps of:
receiving a multi-program transport stream for a scheduled program, wherein the multi-program transport stream has at least a first stream having a first program identifier intended to broadcast the scheduled program and any potential preemptive material and a second stream having a second program identifier intended to broadcast only the scheduled program;
scheduling to record the scheduled program by selecting the first or second program identifier; and
recording the scheduled program selected in the scheduling step.

5. The method of claim 4, wherein the multi-program transport stream is a single channel or a single frequency.

6. The method of claim 4, wherein the first and second streams are subchannels on a channel.

7. The method of claim 4, comprising the step of selecting the first program identifier, thereby recording the scheduled program and preemptive material in the first stream.

8. The method of claim 4, comprising the step of selecting the second program identifier, thereby recording only the scheduled program in the second stream.

9. The method of claim 4, comprising the step of selecting the first program identifier, thereby recording the scheduled program and preemptive material in the first stream and selecting a program start time and a program end time for the recording the scheduled program.

10. The method of claim 4, comprising the step of selecting the second program identifier, thereby recording only the scheduled program in the second stream and selecting a program start time and a program end time for the recording the scheduled program.

11. A device for recording a scheduled program comprising:
a means adapted for receiving data from a multi-program transport stream system that is configured to transmit multiple audio or video programs over a channel in multiple streams, the multi-program transport stream system further providing program identifiers to the streams in the channel that identifies a first program identifier with a first stream having at least a portion of a scheduled program and indentifies a second program identifier with a second stream having the scheduled program in its entirety; and
a storage means adapted for identifying the scheduled program by the second program identifier and recording the scheduled program in its entirety while the unscheduled interrupting program is provided in real time.

12. The device of claim 11, wherein the scheduled program has a program start time and a program end time; and the storage means is adapted to record and store a recording in which the recording has a recorded program start time and a recorded program end time corresponding the program start time and the program end time.

13. The system of claim 12, wherein the recorded program end time does not extend beyond the program end time.

14. A system for managing scheduled and non-scheduled programs comprising:
an encoder for creating a multi-program transport stream from at least a portion of a scheduled program and at least a portion of a unscheduled program, one of the program transport streams including only scheduled program content and another of the program transport streams including both scheduled program content and unscheduled program content, the encoder assigning respective PIDs to the program transport streams indicative of the scheduled and non-schedule content;
a transmitter for the program transport streams;
a decoder for the program transport streams, the decoder providing the scheduled program as a first output and having at least a first PID and the scheduled program and non-scheduled program as a second output having at least a second PID; and
a recorder that is adapted to automatically recognize the first PID and record the first output.
